(19) United States
(12) Patent Application Publication
(10) Pub. No.: US 2009/0097498 A1
(43) Pub. Date: Apr. 16, 2009

(54) COMMUNICATION METHOD, COMMUNICATION APPARATUS, AND INTEGRATED CIRCUIT

(75) Inventors: Shinichiro OHMI, Osaka (JP); Hideki Homma, Fukuoka (JP); Yoshio Urabe, Nara (JP); Yoshinori Okazaki, Osaka (JP); Yosuke Matsushita, Osaka (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., OSAKA (JP)

(21) Appl. No.: 12/130,624

(22) Filed: May 30, 2008

(30) Foreign Application Priority Data
May 31, 2007 (JP) 2007-145973

(51) Int. Cl. H04L 12/43

(52) U.S. Cl. 370/461

(57) ABSTRACT

A communication apparatus for communicating by commonly sharing a transmission channel with another communication apparatus which performs a data transmission, comprising: a transmitting unit which transmits first data at first timing and second data at second timing subsequent to the first timing to the transmission channel; and an information adding unit which adds time slot information to the first data, the time slot information indicating a time slot during which the second data is transmitted prior to the data transmission performed by the other communication apparatus.

### BACKGROUND

1. Technical Field

The present invention is related to a communication method and a communication apparatus by which communication operations are carried out among a plurality of communication apparatuses which commonly share a communication band, and an integrated circuit thereof.

2. Background Art

In communication systems such as power line communication systems and wireless LAN (Local Area Network) systems in which communication operations are performed among a plurality of communication apparatuses which commonly share communication bandwidth, even when various types of data are present on transmission channels in mixing manners, QoS (Quality of Service) is required to be secured. More specifically, in such a case that while data to be transmitted are cyclic and such data whose delay conditions are restricted, for instance, VoIP (Voice over Internet Protocol) data and video stream data are transmitted, if variations are generated in the communication bands, then interruptions of data may occur. As a consequence, it is required to transmit these data while maintaining sufficient broad communication bandwidth.

FIG. 15(a) shows input timing of data which should be transmitted, whereas FIG. 15(b) indicates packets (frames) appeared on a transmission channel (namely, power line in power line communication). As indicated in FIG. 15(a), data “D1” to data “D5” which should be transmitted correspond to data having such a delay condition that these data “D1” to “D5” are basically inputted in a constant interval “T₀” (for example, 20 ms), and are transmitted within a constant time “Tt” (for instance, 5 ms) after these data “D1” to “D5” have been inputted. These data “D1” to “D5” are, for example, VoIP data, and are generally continued data.

In the example represented in FIG. 15(b), both a packet “P1” corresponding to the data “D1”, and another packet “P2” corresponding to the data “D2” have been transmitted and then have been received under normal condition, while the delay condition can be satisfied, whereas a packet “P3” corresponding to the data “D3” cannot satisfy the delay condition. Also, although a packet “P4” corresponding to the data “D4” has been transmitted within the constant time “Tt”, this packet “P4” has not been received under normal condition. A re-transmitted packet “Q4” of this packet “P4” cannot satisfy the delay condition. On the other hand, as to a packet “P5” corresponding to the data “D5”, since the packet “P5” transmitted within the constant time “Tt” could not be received under the normal condition, a packet “Q5” has been re-transmitted within the constant time “Tt” and then has been received under the normal condition. Such a status is caused by that a packet “Px” (only one packet is denoted as a representative packet) is transmitted from another communication apparatus via a transmission channel, so that QoS (Quality of Service) cannot be satisfied.

As one method capable of avoiding the above-described condition, a communication operation is carried out by utilizing the TDMA (Time Division Multiple Access) system. Input timing indicated in FIG. 16(a) of data which should be transmitted is identical to the input timing shown in FIG. 15(a). FIG. 16(b) represents packets appeared on a transmission channel.

A TDMA schedule is notified to all of terminals (namely, communication apparatuses) by control frames (annunciation frames and beacons) B1, B2, - - - transmitted from a management terminal (communication apparatus corresponding to master apparatus). When data whose delay must be compensated is transmitted, generally speaking, a TDMA schedule time cycle (beacon time cycle) is not made coincident with a time cycle of the data (for example, VoIP data) whose delay must be compensated, so that it is required to set a TDMA allocation time cycle “Ts” shorter than or equal to a delay condition. In the example of FIG. 16, since the TDMA allocation time cycle “Ts” is equal to “4 ms”, packets “P1” to “P5” corresponding to input data “D1” to “D5” at such timing capable of satisfying the delay condition (shorter than or equal to 5 ms) from the input data “D1” to “D5.”

As previously described, if the TDMA system is employed, then the data transmission can be carried out without being disturbed by packets transmitted from other terminals, while the delay condition can be satisfied. However, as previously described, since the TDMA allocation time cycle “Ts” must be set shorter than or equal to the delay condition, such slots “Sp” (only one slot is denoted as symbol “Sp” in FIG. 16(b)) are increased which are not actually used among slots allocated to the terminals which transmit the input data “D1” to “D5.” As a result, there is no way capable of avoiding that a transmission efficiency is lowered. Also, other data frames “Py” (only one frame is denoted as symbol “Py” in FIG. 16(b)) are sub-divided, which may also lower the transmission efficiency.

As previously explained, in the TDMA system, the time slot reservation period is increased longer than the actually required time slots, so that useless time slots are generated. Also, a large number of sub-divided frames are generated, so that the entire time slots are decreased due to the overhead (namely, frame headers, and frame-to-frame gaps).

As another method capable of performing a data transmission by satisfying a delay condition, the data transmission is carried out by employing the RSVP (Reservation Protocol) system. Input timing of data shown in FIG. 17(a) which should be transmitted is identical to the input timing of FIG. 15(a). FIG. 17(b) represents packets appeared on a transmission channel, and FIG. 17(c) indicates reservation operation timing of a management terminal (namely, communication apparatus corresponding to master apparatus).

This RSVP system is designed as follows: That is, a reservation period is not uniformly determined based upon control frames “B1” and “B2” transmitted from the management terminal, but when reservation requests “Rq1”, “Rq2”, - - - are issued from such terminals which require reservations, reservation annunciations “Ra1”, “Ra2”, - - - , are transmitted to all of these terminals.

In the example of FIG. 17, after a packet “P1” corresponding to data “D1” has been transmitted, a reservation request “Rq1” is transmitted to the master terminal, while the reservation request “Rq1” is to reserve a period for transmitting next data “D2.” The master terminal sets a reservation period “Rv1” based upon the reservation request “Rq1”, and transmits a reservation annunciation “Ra1” used to annunciate setting of the reservation period “Rv1” to all of these terminals. As a consequence, the reservation period “Rv1” is allocated to such a terminal which has sent the reservation request “Rq1”, and other terminals do not transmit data. As a result, a packet “P2” corresponding to the data “D2” can be transmitted at such a timing which can satisfy the delay condition. Then, after the packet “P2” has been transmitted, since a similar process operation to the above-described process operation is carried out, the cyclic data whose delay conditions are restricted can be firmly transmitted. It should also be understood that in the example shown in FIG. 17, since a packet “P3” had not be received under normal condition, a packet “Q3” has been re-transmitted. However, since such a period capable of satisfying the delay condition has been reserved, the packet retransmission has been carried out without any problem.

However, in accordance with the above-described RSVP system, an overhead for reservation time slots is similarly large, and the time slots are consumed. Also, if a time slot reservation fails, then a data frame cannot be transmitted, so that QoS cannot be satisfied. The above-described time slot reservation overhead implies such a process operation required to reserve a time slot, or a time required for executing the above-described process operation.

As the communication systems capable of performing the time slot reservations, for instance, there are proposed communication systems disclosed in a patent publication 1 (JP-A-2004-80612), and a patent publication 2 (JP-A-2003-60696). However, overheads for reservation time slots of these conventional communication systems are large.

### SUMMARY

The below-mentioned embodiments are made to solve the above-described problems, and therefore, have an object to provide a communication method, a communication system, and a communication apparatus for accomplishing the communication method capable of performing a transmission of cyclic data whose delay condition is restricted, while QoS (Quality of Service) is secured.

A communication apparatus, according to the below-mentioned embodiment of the present invention, is featured by such a communication apparatus for communicating by commonly sharing a transmission channel with another communication apparatus which performs a data transmission, comprising: a transmitting unit which transmits first data at first timing and second data at second timing subsequent to the first timing to the transmission channel; and an information adding unit which adds time slot information to the first data transmitted from the transmitting unit, the time slot information corresponding to time slots during which the second data is transmitted prior to the data transmission performed by the other communication apparatus.

Since the time slot information corresponding to the time slots during which the second data transmitted at the second timing subsequent to the first timing is transmitted through the transmission channel is added to the first data transmitted at the first timing, the data whose delay condition is restricted can be transmitted while the QoS (Quality of Service) is maintained. Furthermore, since the time slot reservation overhead is decreased, the time slots on the transmission channel can be effectively utilized, so that the transmission efficiency can be improved.

A communication method, according to the below-mentioned embodiment of the present invention, is featured by such a communication method for communicating by commonly sharing a transmission channel with another communication apparatus which performs a data transmission, comprising: transmitting first data at first timing to the transmission channel; transmitting second data at second timing subsequent to the first timing to the transmission channel; and adding time slot information to the first data, the time slot information corresponding to time slots during which the second data is transmitted prior to the data transmission performed by the other communication apparatus.

Since the time slot information corresponding to the time slots during which the second data transmitted at the second timing subsequent to the first timing is transmitted through the transmission channel is applied to the first data transmitted at the first timing, the data whose delay condition is restricted can be transmitted while the QoS (Quality of Service) is maintained. Furthermore, since the time slot reservation overhead is decreased, the time slots on the transmission channel can be effectively utilized, so that the transmission efficiency can be improved.

An integrated circuit, according to the below-mentioned embodiment of the present invention, is featured by such an integrated circuit employed in a communication apparatus for communicating by commonly sharing a transmission channel with another communication apparatus which performs a data transmission, comprising: a transmitting unit which transmits first data at first timing and second data at second timing subsequent to the first timing to the transmission channel; and an information adding unit which adds time slot information to the first data transmitted from the transmitting unit, the time slot information corresponding to time slots during which the second data is transmitted prior to the data transmission performed by the other communication apparatus.

Since the time slot information corresponding to the time slots during which the second data transmitted at the second timing subsequent to the first timing is transmitted through the transmission channel is applied to the first data transmitted at the first timing, the data whose delay condition is restricted can be transmitted while the QoS (Quality of Service) is maintained. Furthermore, since the time slot reservation-purpose overhead is decreased, the time slots on the transmission channel can be effectively utilized, so that the transmission efficiency can be improved.

In accordance with the above-described communication apparatus, communication method, and integrated circuit, it is possible to provide the communication method, the communication system, and the communication apparatus for accomplishing the communication method capable of performing the transmission of the data in the periodic manner, the delay condition of which is restricted, while the QoS (Quality of Service) is maintained.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a schematic diagram for showing one example as to a power line communication system for realizing a communication method and a communication system, according to an embodiment of the present invention;

FIG. 2A is a diagram for indicating an outer appearance perspective view of a PLC modem according to the embodiment;

FIG. 2B is a diagram for indicating an outer appearance front view of the PLC modem according to the embodiment;

FIG. 2C is a diagram for indicating an outer appearance rear view of the PLC modem according to the embodiment;

FIG. 3 is a block diagram for showing one example as to hardware of the PLC modem according to the embodiment;

FIG. 4 is a diagram for describing one example as to a digital signal processing operation executed in the PLC modem according to the embodiment;

FIG. 5 is a diagram for showing one example as to data transmission timing in the power line communication system according to the embodiment;

FIG. 6 is a diagram for showing one example as to transmission timing of VoIP data in the power line communication system according to the embodiment;

FIG. 7 is a diagram for explaining a method of acquiring data contained in reservation information in the power line communication system according to the embodiment;

FIG. 8 is a diagram for explaining a utilization of an annunciation frame equipped with a time slot reservation in the power line communication system according to the embodiment;

FIG. 9 is a schematic operation flowchart in the case that a PLC modem corresponding to a master modem transmits an annunciation frame equipped with a time slot reservation in the power line communication system according to the embodiment;

FIG. 10 is a schematic operation flowchart in the case that a PLC modem corresponding to a slave modem transmits VoIP data in the power line communication system according to the embodiment;

FIG. 11 is a schematic operation flowchart of a PLC modem which receives a data frame in the power line communication system according to the embodiment;

FIG. 12 is a diagram for showing transmission timing in such a case that input data is entered at irregular timing in the power line communication system according to the embodiment;

FIG. 13 is a diagram for explaining a calculation of a time cycle of a reservation period in the power line communication system according to the embodiment;

FIG. 14 is a diagram for showing transmission timing in such a case that the CSMA system and the TDMA system are commonly used in the power line communication system according to the embodiment;

FIG. 15 is a diagram for showing one example as to timing which is required when VoIP data is transmitted;

FIG. 16 is a diagram for showing one example as to timing in such a case that VoIP data is transmitted based upon the TDMA system; and

FIG. 17 is a diagram for showing one example as to timing in such a case that VoIP data is transmitted based upon the RSVP system.

### DETAILED DESCRIPTION

Referring now to drawings, a description is made of embodiments of the present invention.

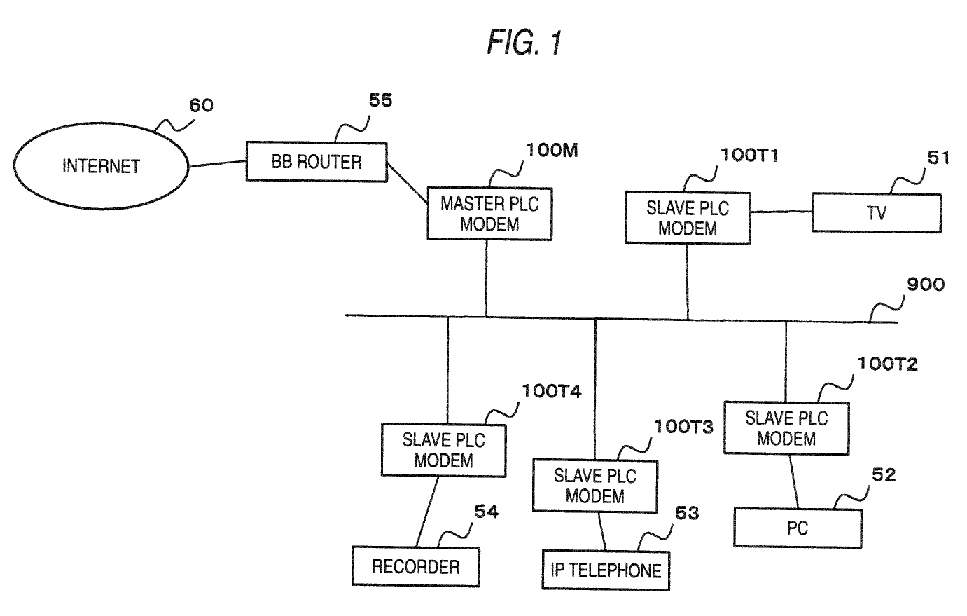

The power line communication system of FIG. 1 is provided with plural sets of PLC (Power Line Communication) modems 100M, 100T1, 100T2, 100T3, and 100T4, which are connected to a power line 900. Although 5 sets of PLC modems 100M, 100T1, 100T2, 100T3, 100T4 have been illustrated in FIG. 1, numbers of PLC modems to be connected to the power line 900 may be arbitrarily selected. The PLC modem 100M functions as a master modem, and manages connection conditions (link conditions) of other PLC modems 100T1 to 100T4, which function as slave modems. A PLC modem function as a master modem is not always necessarily required.

In the below-mentioned explanations, when a description is made of both the master modem and a specific slave modem, these master modem and specific slave modem will be described as the PLC modems 100M, 100T1, 100T2, 100T3, and 100T4, respectively; when a description is made of, generally speaking, a slave modem, this slave modem will be described as a PLC modem 100T; and also, when a description is made of such a PLC modem which is not limited only to a master modem and slave modems, this PLC modem will be simply described as a PLC modem 100.

Although the power line 900 has been indicated by employing 1 line in FIG. 1, the power line 900 is actually constructed by employing two or more pieces of conducting wires. The PLC modem 100 has been connected to two pieces of conducting wires within these plural conducting wires.

As will be later explained in detail, while the PLC modem 100 has been provided with a LAN (Local Area Network) modular jack 103 such as RJ45, a television (TV) 51, a personal computer (PS) 52, an IP telephone 53, a recorder 54, and a broadband router 55 have been connected to the modular jack 103. The broadband router 55 has been connected to the Internet. It should also be noted that the power line communication system is one example as to the communication systems capable of realizing the communication method according to the present invention. Alternatively, other communication systems such as a wireless LAN may be employed.

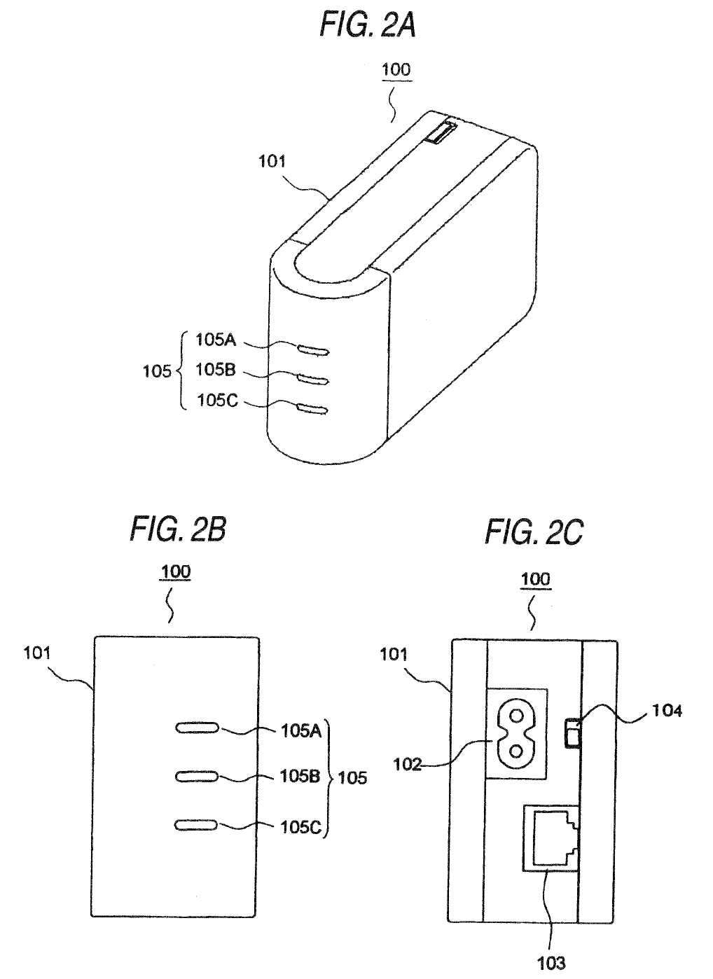

FIG. 2A is an outer appearance perspective view for representing a front plane of this PLC modem 100; FIG. 2B is a front view of the PLC modem 100; and FIG. 2C is a rear view of the PLC modem 100. The PLC modem 100 shown in FIG. 2A, 2B, 2C has contained a housing 101, and a display unit 105 has been provided on a front plane of the housing 101. As indicated in FIG. 2A and FIG. 2C, the display unit 105 has been constituted by LEDs (Light Emitting Diodes) 105A, 105B, and 105C. Also, as represented in FIG. 2C, a power supply connector 102, a LAN (Local Area Network) modular jack 103 such as RJ45, and a selecting switch 104 for selectively switching operation modes have been provided on a rear plane of the housing 101. A power supply cable (which is not shown in FIG. 2A, 2B, 2C) is connected to the power supply connector 102; a LAN cable (which is not indicated in FIG. 2A, 2B, 2C) is connected to the modular jack 103. It should also be understood that while a D-SUB (D-subminiature) connector may be provided in the PLC modem 100, a D-SUB cable may be alternatively connected to this D-SUB connector.

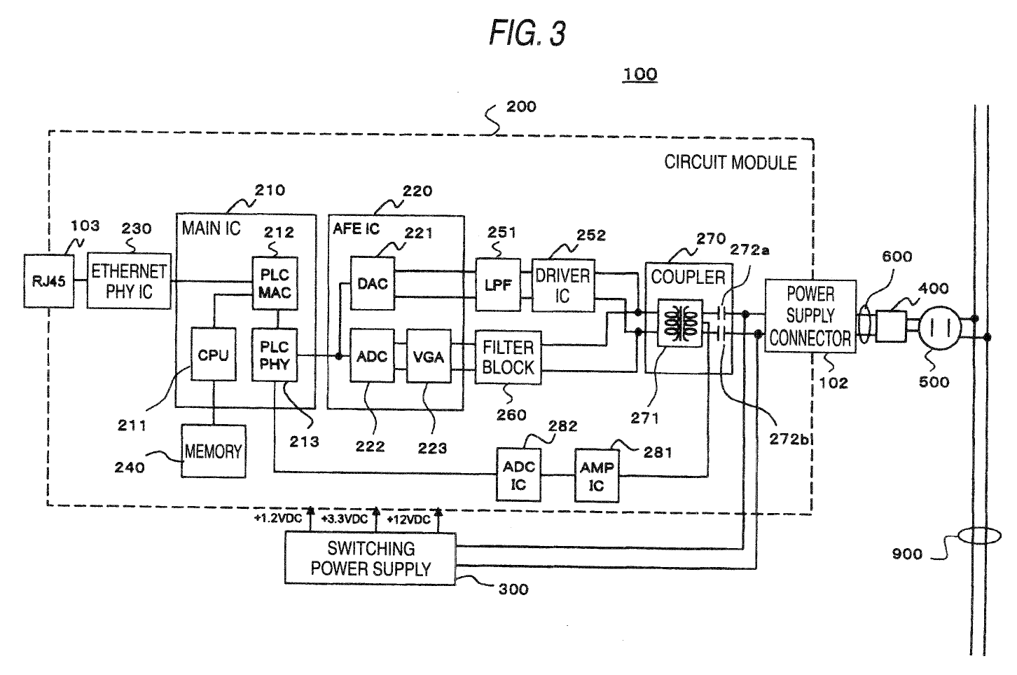

As shown in FIG. 3, the PLC modem 100 has contained a circuit module 200 and a switching power supply 300. The switching power supply 300 supplies various types of voltages (for example, +1.2 V, +3.3 V, and +12 V) to the circuit module 200, and is arranged by containing, for example, a switching transformer and a DC-to-DC converter, which are not shown.

In the circuit module 200, a main IC (Integrated Circuit) 210, an AFE•IC (Analog Front End•Integrated Circuit) 220, an Ethernet PHY•IC (Physical Layer•Integrated Circuit) 230, a memory 240, a low-pass filter (LPF) 251, a driver IC 252, a band-pass filter (BPF) 260, a coupler 270, an AMP (amplifier) IC 281, and an ADC (A/D converting) IC 282 have been provided. Both the switching power supply 300 and the coupler 270 are connected to the power supply connector 102, and further, are connected via a power supply cable 600, a power supply plug 400, and an outlet 500 to the power line 900. It should also be noted that the main IC 210 functions as a control circuit for performing a power line communication.

The main IC 210 has been constituted by a CPU (Central Processing Unit) 211, a PLC•MAC (Power Line Communication•Media Access Control layer) block 212, and a PLC•PHY (Power Line Communication•Physical layer) block 213. The CPU 211 has mounted a 32-bit RISC (Reduced Instruction Set Computer) processor. The PLC•MAC block 212 manages MAC layers (Media Access Control layers) of transmission/reception signals, and the PLC•PHY block 213 manages PHY layer (Physical layers) of transmission/reception signals. The AFE•IC 220 has been arranged by a D/A converter (DAC) 221, an A/D converter (ADC) 222, and a variable gain amplifier (VGA) 223. The coupler 270 has been constituted by a coil transformer 271 and coupling-purpose capacitors 272a and 272b. It should also be understood that the CPU 211 controls operations of the PLC•MAC block 212 and the PLC•PHY block 213, and also, controls the entire operations of the PLC modem 100 by utilizing data stored in the memory 240.

Briefly speaking, a communication operation by the PLC modem 100 is carried out in accordance with the below-mentioned manner. Data entered from the modular jack 103 is transferred via the Ethernet PHY•IC 230 to the main IC 210, and the transferred data is processed by a digital signal processing operation, so that a digital transmission signal is generated. The generated digital transmission signal is converted into an analog signal by the D/A converter (DAC) 221 of the AFE•IC 220, and then, the converted analog signal is outputted via the low-pass filter 251, the driver IC 252, the coupler 270, the power supply connector 102, the power supply cable 600, the power supply plug 400, and the outlet 500 to the power line 900.

A signal received from the power line 900 is transferred via the coupler 270 to the bandpass filter 260, and then, a gain of the filtered analog signal is controlled by the variable gain amplifier (VGA) 223 of the AFE•IC 220, and thereafter, the gain-controlled analog signal is converted into a digital signal by the A/D converter (ADC) 222. Then, the converted digital signal is transferred to the main IC 210, and the transferred digital signal is processed by the digital signal processing operation so as to be converted into digital data. The converted digital data is outputted via the Ethernet PHY•IC 230 from the modular jack 103.

A description is made of one example as to the digital signal process operations which are realized by the main IC 210. The PLC modem 100 performs a multi-carrier communication by employing a plurality of sub-carriers of the OFDM (Orthogonal Frequency Division Multiplexing) system, and the like. The digital signal process operations which convert transmission data into an OFDM transmission signal, and also convert an OFDM reception signal into reception data are mainly carried out by the PLC•PHY block 213.

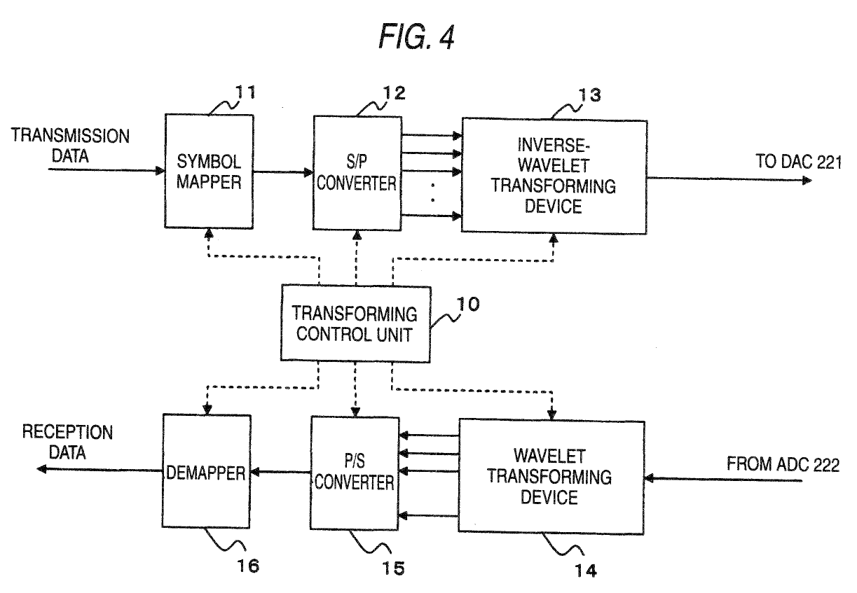

FIG. 4 is a functional block diagram for describing one example as to the digital signal process operations realized in the PLC•PHY block 213, namely, for explaining such a case that the PLC•PHY block 213 performs an OFDM transmission by utilizing a wavelet transform. As indicated in FIG. 4, the PLC•PHY block 213 has functions as a transforming control unit 10, a symbol mapper 11, a serial-to-parallel converter (S/P converter) 12, an inverse-wavelet transforming device 13, a wavelet transforming device 14, a parallel-to-serial converter (P/S converter) 15, and a de-mapper 16.

The symbol mapper 14 converts bit data which should be transmitted into symbol data, and performs a symbol mapping operation (for example, PAM modulation) in accordance with the respective symbol data. The S/P converter 15 converts serial data which have been mapped into parallel data. The inverse-wavelet transforming device 13 performs an inverse-wavelet transforming operation with respect to the parallel data so as to obtain data on a time axis, namely generates a sample value series indicative of transmission symbols. This sample value series data is supplied to the D/A converter (DAC) 221 of the AFE•IC 220.

The wavelet transforming device 14 performs a discrete wavelet transforming operation with respect to reception digital data obtained from the A/D converter (ADC) 222 of the AFE•IC 220 onto a frequency axis. The above-described reception digital data corresponds to such a sample value series which has been sampled in the same sampling rate as that when the digital data is transmitted. The demapper 19 calculates amplitude values of the respective sub-carriers so as to judge a reception signal, and thus, acquires reception data.

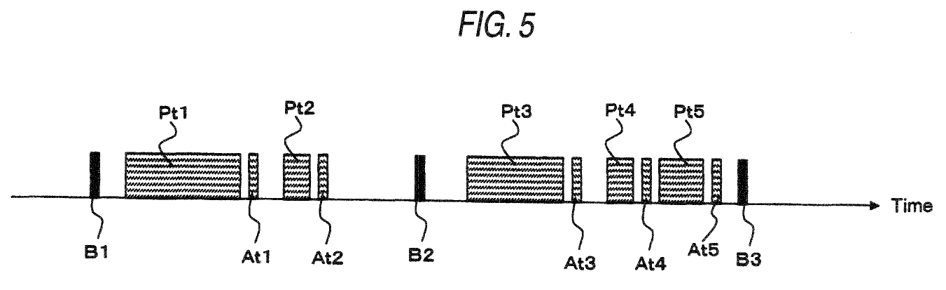

In the power line communication system shown in FIG. 1, in such a case that a data transmission operation is carried out, as represented in FIG. 5, the PLC modem 100 functioning as a transmission source transmits data frames “Pt1” to “Pt5”; when the PLC modem 100 functioning as a transmission destination can receive the data frames Pt1 to Pt5 under normal condition, the PLC modem 100 of the transmission destination transmits acknowledgement frames “At1” to “At5.” Information employed in order to manage communications established among the respective PLC modems 100 is transmitted from the PLC modem 100M as annunciation frames (control frames and beacons) B1, B2, B3, - - - in a constant time interval.

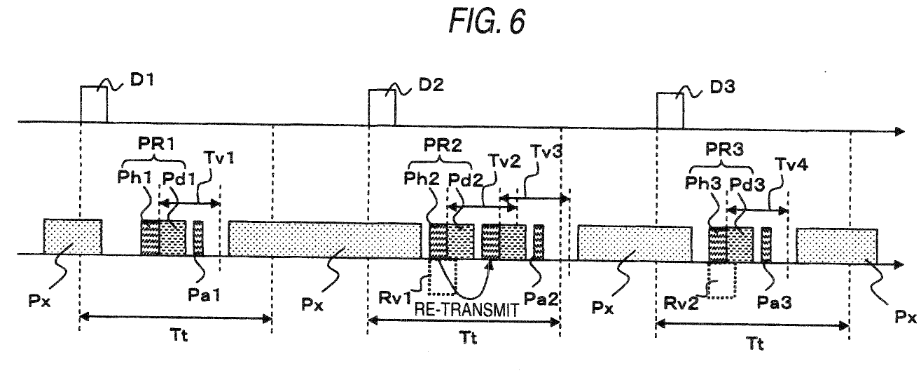

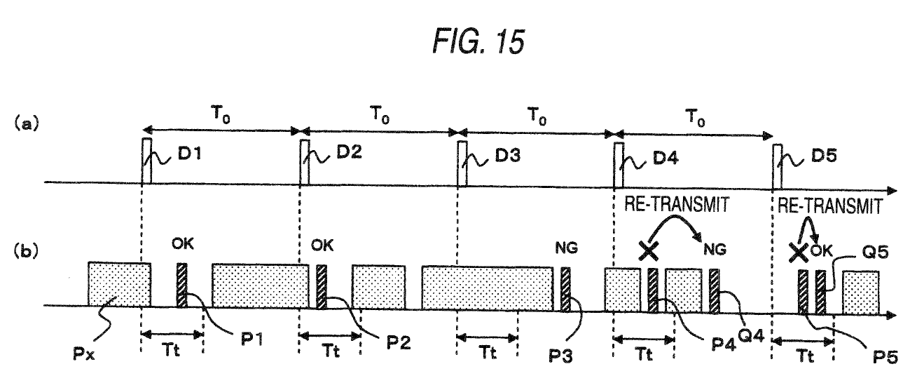

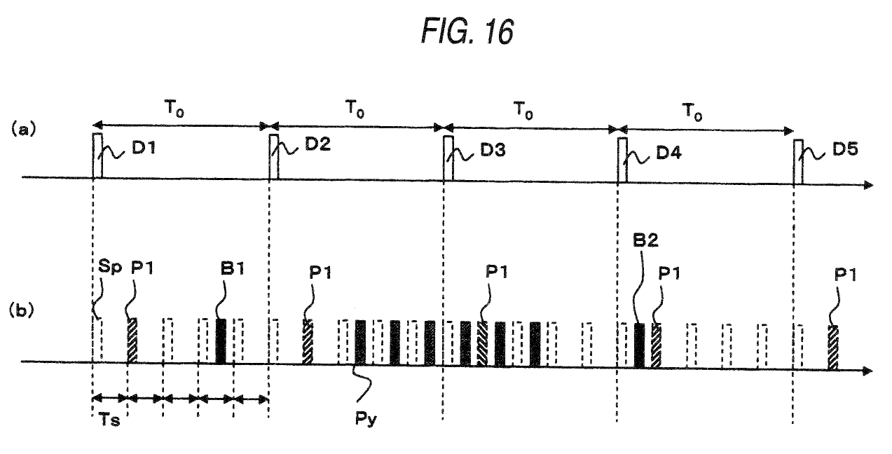

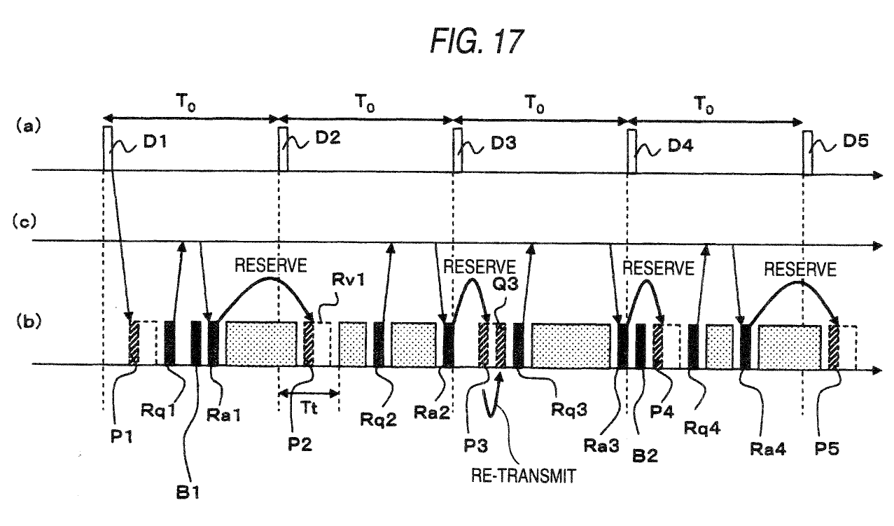

Also, in the case that a cyclic data whose delay condition is restricted such as VoIP data and video stream data are transmitted, this data transmission is carried out at such a timing as indicated in FIG. 6. FIG. 6 indicates one example as to timing in the case that VoIP data D1 to D3 described in FIG. 15 to FIG. 17 are transmitted. The VoIP data D1 to D3 to be inputted correspond to data having such a delay condition that these VoIP data D1 to D3 are basically inputted in a constant time interval “To” (for example, 20 ms), and then, are transmitted within a constant time “Tt” (for instance, 5 ms) after these data VoIP D1 to D3 have been inputted.

Data frames to be transmitted in correspondence with the data D1 to D3 are basically transmitted within a reserved period. The reservation is made based upon reservation information added to a header portion of a data frame. The reservation information has contained both reservation starting time instant information and reservation time slot information. The reservation starting time instant information indicates a starting time instant at which next data is transmitted. The reservation time slot information indicates a time width (time slot) of a reservation period used to transmit the next data. Also, the reservation information may alternatively contain reservation time cycle information indicative of a time cycle during which a reservation period is set, and this time cycle is 20 ms in this example, since data frames are transmitted in correspondence with the input time cycles of the data D1 to D3. As previously described, such a PLC modem 100 which has received data frames (namely, data frames equipped with time slot reservations) in which reservation information is contained in headers thereof sets reservation period which are indicated by reservation information respectively as transmission prohibition period during which data frames cannot be transmitted.

A transmission prohibition period implies such a time range that a PLC modem 100 which has received a data frame equipped with a time slot reservation does not perform a data transmission operation.

In the example shown in FIG. 6, a data frame “PR1” contains a header “Ph1” and a payload “Pd1.” Then, when another PLC modem 100 which has received the data frame PR1 receives the header “Ph1”, this PLC modem 100 prohibits the own transmission for a time cycle “Tv1” during which the above-described data frame “PR1” and an acknowledgement frame “Pa1” corresponding to this data frame “PR1” are transmitted, and also sets a reservation period “Rv1” as a transmission prohibition period. This reservation period “Rv1” is provided in order to transmit next data which is obtained from the reservation information of the header “Ph1.”

Then, while next reservations are sequentially made, data frames PR1, PR2, - - - , are transmitted. In the example of FIG. 6, since the data frame PR2 of the data D2 cannot be received under normal condition, this data frame PR2 is re-transmitted. As a consequence, the PLC modem 100 which has received the re-transmitted data frame “PR2” prohibits to transmit not only for the time cycle “Tv2”, but also for another time cycle “Tv3.”

A condition as to whether or not the PLC modem 100 can receive a data frame equipped with a time slot reservation may largely depend upon a location where the PLC modem 100 has been connected.

In FIG. 1, such a case is considered in which the data frame equipped with the time slot reservation has been transmitted from the PLC modem 100T2. Generally speaking, there is such a trend that the further a location is separated apart from the position to which the PLC modem 100T2 has been connected, the more the data frame equipped with the time slot reservation can be hardly received. Different from a leased communication line, various types of noises (for example, periodic noises generated from domestic electric appliances) are present on a power line, so that the above-described trend may especially become conspicuous.

In FIG. 1, since both the PCL modem 10T1 and the PLC modem 100T3 have been connected to the locations near the PLC modem 100T2, probability capable of receiving the data frame equipped with the time slot reservation as to these PLC modems 100T1 and 100T3 becomes high. On the other hand, both the PLC modem 100M and the PLC modem 100T4 have been connected to the locations separated apart from the PLC modem 100T2, as compared with the PLC modems 10T1 and 100T3. As a result, probability capable of receiving the data frame equipped with the time slot reservation as to these PLC modems 100M and 100T4 becomes low, as compared with that of the PLC modems 100T1 and 100T3.

In such a case, it is preferable that the PLC modems 100T1 and 100T3 which could succeed in receiving the data frame equipped with the time slot reservation copy reservation information and adds the copied reservation information to an acknowledgement frame (Pa1 etc.) corresponding to the data frame equipped with the time slot reservation, and then, transmits the copied reservation information-added data frame as an acknowledgement frame equipped with the time slot reservation.

Since the PLC modems 100T1 and 100T3 have been connected to the locations close to the PLC modem 100M and the PLC modem 100T4, as compared with the PLC modem 100T2, probability at which the PLC modems 100M and 100T4 receive acknowledgement frames equipped with time slot reservations which are transmitted from the PLC modems 100T1 and 100T3 may become higher than probability at which the PLC modems 100M and 100T4 receive a data frame equipped with a time slot reservation which is transmitted from the PLC modem 100T2.

When the PLC modems 100 are arranged in the above-described manner, a total number of the PLC modems 100 which fail in acquisitions of the reservation information can be decreased. As a result, such a probability that frames may collide with each other on the power line 900 is lowered. As a consequence, a transmission efficiency of the communication system can be improved.

As indicated in FIG. 6, time widths of reservation period “Rv1”, “Rv2”, - - - need not be equal to data frame lengths, but may be equal to time lengths during which a PLC modem 100 which has been reserved with a priority prior to other PLC modems 100 can commence to transmit data frames (namely, minimum time is equal to data frame detection time). Since the data frame transmission is prohibited only for this time length, other PLC modems 100 can firmly detect the data frame transmitted from the reserved PLC modem 100. In such a case that other PLC modems 100 detect the data frame transmitted from the reserved PLC modem 100, these PLC modems 100 can stop transmissions of data frames at least until this detected data frame is accomplished, and an acknowledgement frame with respect to this data frame is accomplished (namely, until time cycle such as time cycle “Tv1” is accomplished). As a consequence, transmission frames “Px” from other PLC modems 100 are not overlapped with the data frames “PR1” to “PR3.”

Alternatively, the PLC modem 100 functioning as the transmission source may establish a schedule in such a manner that reservation time cycles (namely, time slots which are reserved by respective PLC modems 100 for data transmissions) are not overlapped with each other by sequentially and previously detecting other reservation information; and thus, may set the own reservation information. For instance, in such a case that a reservation has been made earlier than the own desirable reservation starting time instant and therefore this reserved time instant is temporally overlapped with the own desirable reservation starting time instant, the PLC modem 100 may set a reservation starting time instant to later than or equal to an earlier reservation ending time instant so as to adjust a content of reservation information to be transmitted.

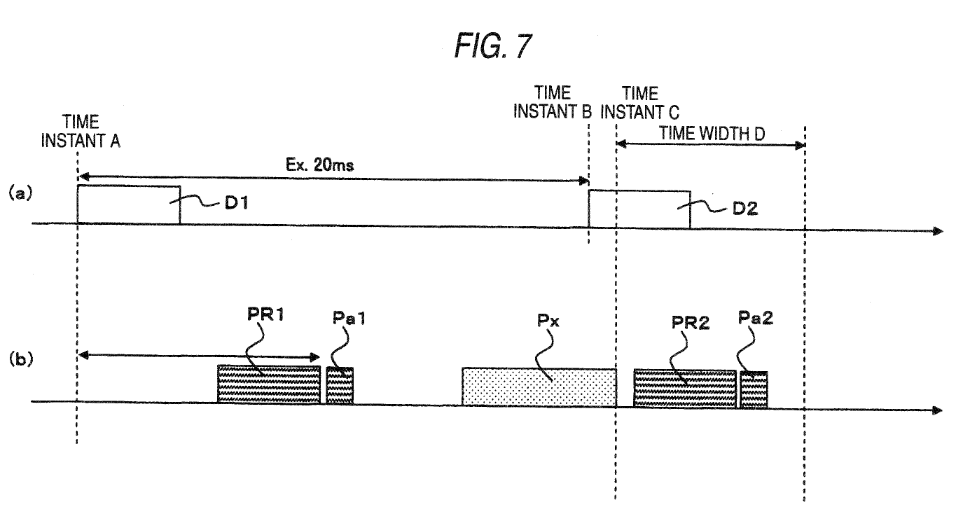

Next, a description is made of a method for acquiring data contained in reservation information with reference to FIG. 7. Timing shown in FIG. 7 represents that the transmission time cycles of the data frames “PR1” and “PR2” of FIG. 6 are enlarged. When data “D1” is inputted, both a time instant “C” and a time width “D” are calculated which are added to the header “Ph1” of the data frame “PR1.” A time instant “B” corresponds to a next time instant of data input. A time instant “C” corresponds to a next starting time instant of a reservation period, and the time width “D” corresponds to a time width of this reservation period. Prior to the calculation as to the time instant “C” and the time width “D”, a time stamp value (time instant “A”) when the data “D1” is inputted is acquired. Then, it is so assumed that time instant “C”=time instant “A”+input time interval “T₀” (20 ms)+adjusting time, and time width “D”=reservation time width. In this case, the adjusting time corresponds to such a value defined by considering jitter of data input and transmitting process time, and is equal to, for example, 3 ms. Then, both the time instant “C” and the time width “D” are added to the header “Ph1” of the data frame “PR1”, and the added data frame “PR1” is transmitted. Also, although the time instant “A” is defined as the time stamp when the data D1 is inputted, this time instant “A” may be alternatively defined as such a reference time based upon a plurality of D1-data inputs. This reference time is calculated by considering an averaged time cycle, for example, while an averaged time instant as to a plurality of D1-data input time stamps is employed as a reference time instant.

When the data “D2” is inputted, this process operation is carried out in a similar manner, and then, is continuously carried out until data to be inputted indicates last data. It should also be noted that the time instant “C” which is added to a header need not be an absolute time, but may be equal to, for example, an offset time defined from a transmission time instant of a frame. Also, not only both the starting time instant “A” and the time width “D”, but also the time cycle (20 ms in this example) of the reservation period may be added to a header of a data frame so as to transmit the added data frame. If a reservation time cycle has been acquired, even when reservation information could not be acquired in a periodic manner, a transmission prohibition period may be set based upon such a reservation time cycle information which has been acquired in the preceding time, so that the reservation period may be firmly secured.

Alternatively, in such a case that reservation information does not contain such an information indicative of a time cycle for a reservation period, the time cycle for the reservation period may be calculated from an interval between reception time instants of data frames which were received in the past; and in the case that reservation information could not be acquired in the periodic manner, a reservation period may be set by utilizing the time cycle information of this calculated reservation period.

In the above description, the reservation information which has been added to the header of the data frame and then has been transmitted is acquired by receiving such a data frame equipped with the time slot reservation, or by receiving such an acknowledgement frame equipped with the time slot reservation that the PLC modem 100 which has received the data frame as the frame for the own destination copies the reservation information to the acknowledgement frame and then transmits the reservation information-copied acknowledgement frame. Alternatively, the reservation information may be acquired by furthermore receiving an annunciation frame from the PLC modem 100M corresponding to the master modem.

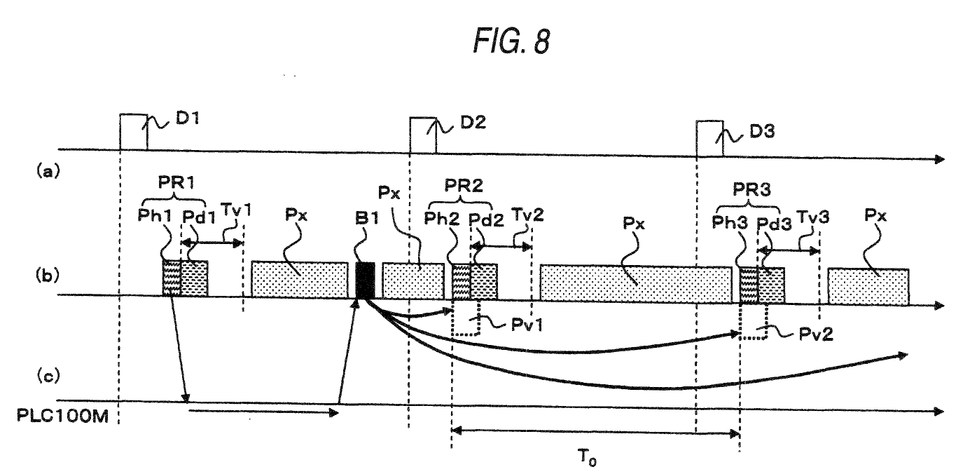

Referring now to FIG. 8, a description is made of a utilization of an annunciation frame equipped with a time slot reservation. Since the data D1 to D3, the data frames PR1 to PR3, and the transmission data frames Px of other PLC modems 100 have been previously described in detail, explanations thereof will be omitted. In this example, the PLC modem 100M corresponding to the master modem which has received the data frame PR1 equipped with the time slot reservation adds both a next reservation period “Pv1” and information representative of a reservation period subsequent to the next reservation period “Pv1” to an annunciation frame “B1” based upon acquired reservation information, and then, transmits the added annunciation frame “B1.”

Two or more pieces of reservation period subsequent to the next reservation period “Pv1” is obtained by that when information indicative of a time cycle of a reservation period has been contained in reservation information, this information is added to a reservation period “Tr1.”

Since the annunciation frame “B1” from the PLC modem 100M is transmitted under such a condition that the PLC modems 100T corresponding to all of the slave modems for constructing the power line communication system can receive this annunciation frame “B1”, the PLC modems 100T can firmly acquire such an information indicative of a plurality of reservation period. It should also be understood that the reservation information may be acquired not only from the annunciation frame B1, but also may be acquired from annunciation frames PR2, - - - , equipped with the time slot reservation subsequent to the next annunciation frame. In such a case that the reservation information acquired from the annunciation frame B1 is different from the reservation information acquired from the annunciation frames PR2, - - - , equipped with the time slot reservation, one reservation information (for example, reservation information acquired from annunciation frames PR2, - - - , equipped with time slot reservation) is used with a top priority.

Since the annunciation frame “B1” corresponds to such a signal having a higher noise resistively, probability at which this annunciation frame “B1” can be received even by such a PLC modem 100 connected to a place where a characteristic of a transmission channel is deteriorated becomes high. As a consequence, a total number of such PLC modems 100 which fail in acquisitions of reservation information can be reduced, so that probability at which frames may collide with each other on the power line 900 is lowered. Accordingly, the transmission efficiency of the communication may be improved.

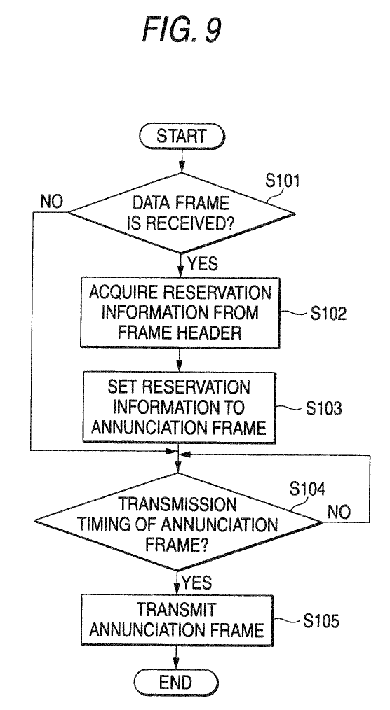

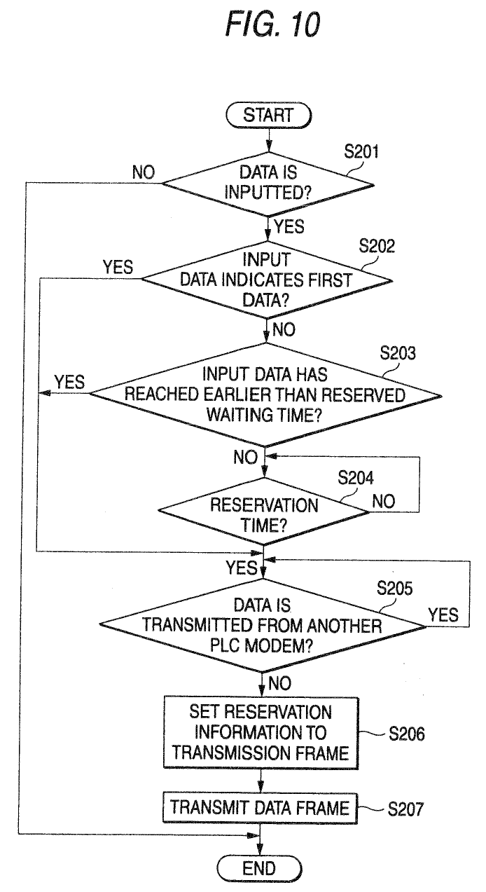

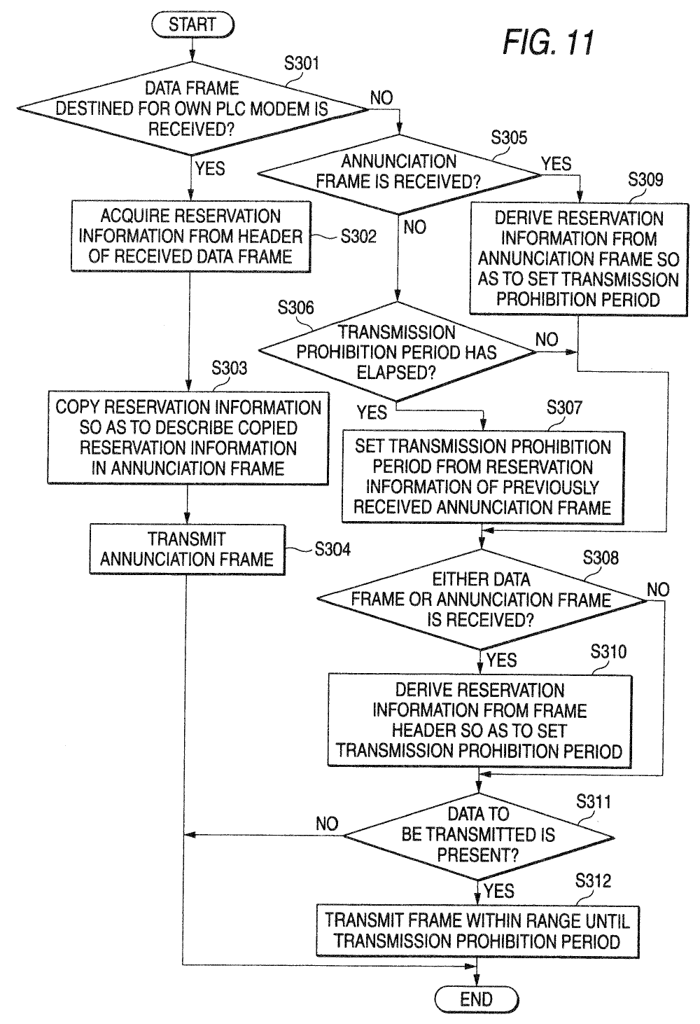

Referring now to FIG. 9, FIG. 10, and FIG. 11, a description is made of a summarized operation of the PLC modem 100 which transmits and/or receives the above-explained reservation information, and also, sets the transmission prohibition period. FIG. 9 is a flow chart for describing a summarized operation performed in such a case that the PLC modem 100M corresponding to the master modem transmits an annunciation frame equipped with a time slot reservation. FIG. 10 is a flow chart for describing a summarized operation performed in such a case that the PLC modem 100T corresponding to the slave modem transmits VoIP data. FIG. 11 is a flow chart for describing a summarized operation performed by the PLC modem 100T which receives a data frame.

In a step S101 of FIG. 9, the PLC modem 100M corresponding to the master modem judges whether or not a data frame equipped with a time slot reservation is received. When the data frame is received, the PLC modem 100M acquires reservation information from a header of the data frame equipped with the time slot reservation in a step S102, and sets the acquired reservation information in a step S103. In such a case that time cycle information of a reservation time cycle has not been incorporated in the reservation information acquired from the data frame equipped with the time slot reservation, the PLC modem 100M may calculate a time cycle of the reservation period from a reception time instant interval of data frames which were received in the past so as to set the reservation information by utilizing the time cycle of the calculated reservation period.

When the PLC modem 100M judges that the data frame equipped with the time slot reservation is not received in the step S101, and after the annunciation frame has been set in the step S103, the PLC modem 100M waits that transmission timing of the annunciation frame becomes active in a step S104. Then, the annunciation frame to which the reservation information has been set is transmitted at the transmission timing of the annunciation frame (step S105).

As previously described, since the annunciation frame from the PLC modem 100M corresponding to the master modem is transmitted under such a condition that the PLC modem 100T corresponding to the slave modem can firmly receive this annunciation frame, the PLC modem 100T can firmly acquire the reservation information.

Next, a description is made of operations of the PLC modem 100T which tries to transmit the VoIP data with reference to FIG. 10. In a step S201, the PLC modem 100T judges whether or not the VoIP data which should be transmitted is inputted. If the VoIP data is not inputted, then the process operation is directly accomplished. When the VoIP data is inputted, the PLC modem 100T judges whether or not this entered VoIP data is first data (step S202). When the entered VoIP data corresponds to the first data, the process operation is advanced to a step S205.

When the entered VoIP data does not indicate the first data, the PLC modem 100T judges whether or not this VoIP data has reached earlier than a reserved waiting time (step S203). This judgment is made in order to judge whether or not data is inputted at irregular timing (namely, this VoIP data is originally inputted in constant time cycle). When the VoIP data has reached earlier than the reserved waiting time (namely, in case of irregular data reach), the process operation is advanced to a step S205. In such a case that the VoIP data has not reached earlier than the reserved waiting time, the PLC modem 100T waits until the reserved time in a step S204, and thereafter, the process operation is advanced to a step S205.

In the step S205, the PLC modem 100T judges whether or not another transmission data is present. If there is no another transmission data, then the PLC modem 100T sets reservation information to a header of a transmission frame (step S206), and then, transmits a data frame equipped with a time slot reservation to which the reservation information has been added in a step S207.

Next, a description is made of operations of the PLC modem 100T which receives a frame with reference to FIG. 11. In a step S301, the PLC modem 100T judges whether or not the received frame corresponds to a data frame equipped with a time slot reservation, which is destined for the own PLC modem 100T. When the received data frame corresponds to such a data frame destined for the own PLC modem 100T, the PLC modem 100T acquires reservation information from a header of the received data frame (step S302). Then, the PLC modem 100T copies the acquired reservation information and describes the copied reservation information in an annunciation frame with respect to the data frame equipped with the time slot reservation destined for the own PLC modem 100T (step S303). In a step S304, the PLC modem 100T transmits the annunciation frame to which the reservation information has been added, and then, accomplishes the process operation.

In the case that the PLC modem 100T judges that the received frame does not indicate the data frame equipped with the time slot reservation destined for the own PLC modem 100T in the step S301, the PLC modem 100T judges whether or not this received frame corresponds to an annunciation frame transmitted from the PLC modem 100M corresponding to the master modem (step S305). When the received frame corresponds to the annunciation frame, the PLC modem 100T derives reservation information from this annunciation frame, and sets a transmission prohibition period based upon the derived reservation information (step S309), and then, the process operation is advanced to a step S308.

In such a case that the PLC modem 100T judges that the received frame does not indicate the annunciation frame in the step S305, the PLC modem 100T judges that the set transmission prohibition period has elapsed (step S306). When the set transmission prohibition period has not yet elapsed, the process operation is advanced to a step S308. When the transmission prohibition period has passed, the PLC modem 100T sets a transmission prohibition period based upon the reservation information of the previously acquired notification frame (step S307), and then, the process operation is advanced to the step S308.

In the step S308, the PLC modem 100T judges whether the received frame is equal to a data frame equipped with a time slot reservation, or an acknowledgement frame equipped with a time slot reservation. If not, then the process operation is advanced to a step S311. To the contrary, in such a case that the received frame is equal to the data frame equipped with the time slot reservation, or the acknowledgement frame equipped with the time slot reservation, the PLC modem 100T derives reservation information contained in this received frame, and sets a transmission prohibition period based upon the derived reservation information, and then, the process operation is advanced to a step S311.

In the step S311, the PLC modem 100T judges whether or not data to be transmitted is present. When there is no such a data, the process operation is directly accomplished. In a step S312, when the data to be transmitted is present, the PLC modem 100T performs a frame transmission within a range until the transmission prohibition period.

It should also be understood that even when the PLC modem 100 receives such a data frame which is not destined for the own PLC modem 100, the PLC modem 100 may alternatively analyze a header of the received data frame so as to acquire reservation information contained in the analyzed header.

As previously described, the following initial condition has been established: That is, data having periodic characteristics such as VoIP data are inputted in a substantially constant time interval. However, there are some possibilities that periodic characteristics of data are disturbed due to an adverse influence caused by an externally provided network and the like, so that the data are inputted at irregular timing.

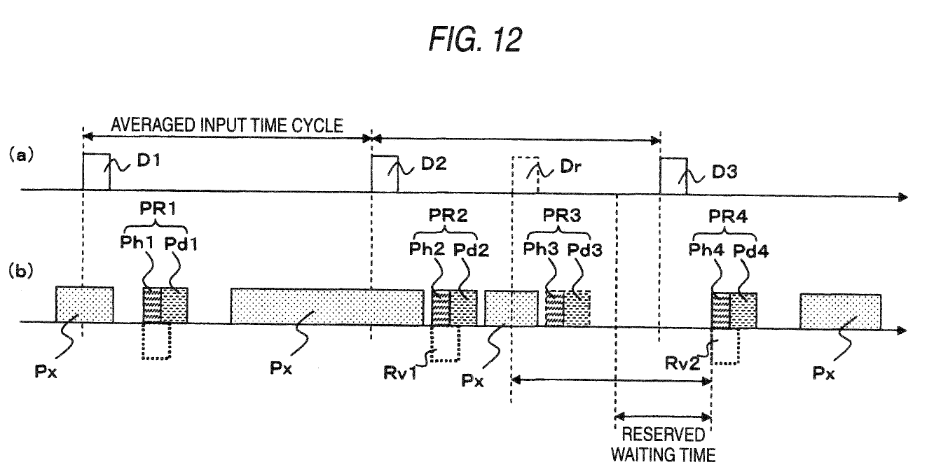

FIG. 12 indicates such a case that irregular data “Dr” has been inputted among periodic input data “D1” to “D3.” When a data frame “PR1” corresponding to the data “D1”, each of the PLC modem 100 sets a reservation period “Rv2” based upon either the data frame PR1 or reservation information added to an acknowledgement frame (not shown) thereof. Then, also in such a case that the data “D2” is inputted, a data frame “PR2” corresponding to this data “D2” is similarly transmitted, and a reservation period “Rv2” is set.

Subsequently, before a reserved waiting time for the data D3 has elapsed, when the irregular data “Dr” is inputted, a data frame “PR3” corresponding to the data “D3” is transmitted as long as transmittable timing is present. At this time, reservation information which is employed so as to set the reservation period “Rv2” for the data “D3” is added to the header “Ph3” of the data frame “PR3”, and then, the added data frame PR3 is transmitted. Since such a data frame transmission is carried out, even when the data is inputted at the irregular timing, the data transmission can be carried out while a delay is reduced as short as possible.

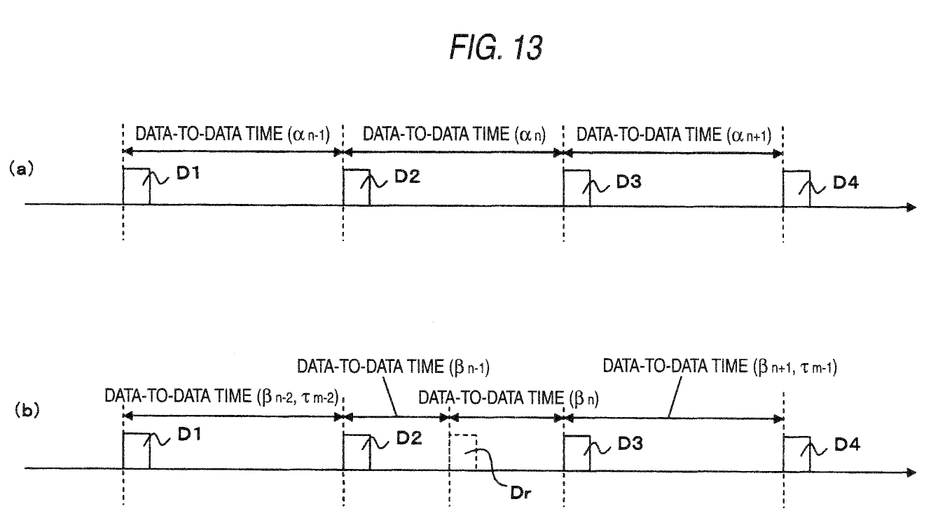

Next, a description is made of a calculation as to a time cycle of a reservation period based upon input timing of data. FIG. 13(a) shows one example in such a case that the data “D1” to “D4” have been inputted in a substantially constant time interval. FIG. 13(b) indicates another example in the case that the irregular data “Dr” has been inputted.

In the case of FIG. 13(a), such a time calculated by averaging an input interval time (namely, data-to-data time) “αₙ” of the data “D1” to “D4” is set as a time cycle of a reservation period. In this case, a reservation time cycle “Pₙ” is calculated by the following equation:

Pₙ=Pₙ₋₁×forgetting coefficient(γ)+αₙ×(1−γ).

In the case of FIG. 13(b), data-to-data time “βₙ” of data for reservation subjects are averaged so as to calculate a time cycle of a reservation period, and a reservation time cycle is calculated except for a data-to-data time outside a range of a predetermined value (J) while the averaged time cycle is set as a center. For example, an averaged time cycle “An” is calculated by the following equation:

Aₙ=Aₙ₋₁×forgetting coefficient(γ)+βₙ×(1−γ).

Also, an averaged time cycle “AvrPeriod” may be alternatively obtained by that time cycles are averaged by employing “τ₀” to “τₘ” except for β(βₙ₋₁, βₙ) which does not become (AvrPeriod)−J<β(AvrPeriod)+J. In addition, a reservation time cycle “Pm” may be calculated by the following equation:

Pₘ=Pₘ₋₁×forgetting coefficient(δ)+τₘ(1(1−δ)).

It should also be understood that the above-described methods for calculating the averaged time cycles and the reference times are merely one example, and therefore, these averaged time cycles and reference times may be alternatively calculated by employing any other methods such as a calculating method using a moving average.

The above-described transmitting and receiving operations of the data frames equipped with the time slot reservations, the transmitting and receiving operations of the acknowledgement frames equipped with the time slot reservations, the transmitting and receiving operations of the control frames are carried out by the PLC•PHY block 213 of the main IC 210.

Also, the process operations for adding the reservation information with respect to the headers of the data frames equipped with the time slot reservations, the headers of the acknowledgement frames equipped with the time slot reservations, and the control frames are carried out by the CPU 211 of the main IC 210.

Also, the process operations for analyzing the headers of the data frames equipped with the time slot reservations, the headers of the acknowledgement frames equipped with the time slot reservations, and the control frames so as to acquire the reservation information are carried out by the CPU 211 of the main IC 210.

Also, the process operations for providing the time range (transmission prohibiting period) for prohibiting the data transmission by employing the reservation information acquired by analyzing the headers of the data frames equipped with the time slot reservations, the headers of the acknowledgement frames equipped with the time slot reservations, and the control frames are carried out by the CPU 211 of the main IC 210.

Also, in the above-described communication apparatus, the time slot information contains both the transmission starting time instant information indicating the transmission starting time instant of the second data, and the time slot width information indicating a time slot width of the time slot.

With employment of the above-described arrangement, the reservation information for reserving the time slots during which the second data transmitted at the second timing subsequent to the first timing is transmitted through the transmission channel is applied to the first data transmitted at the first timing. As a result, the data whose delay condition is restricted can be transmitted while the QoS (Quality of Service) is maintained. Furthermore, since the time slot reservation-purpose overhead is decreased, the time slots on the transmission channel can be effectively utilized, so that the transmission efficiency can be improved.

Also, in the above-described communication apparatus, the transmitting unit transmits the first data and the second data in the predetermined time cycle.

With employment of the above-described arrangement, the data transmission for transmitting the data in the periodic manner can be carried out while the QoS (Quality of Service) is maintained.

Also, the above-described communication system includes: the above-described communication apparatus as a first communication apparatus; and a second communication apparatus including: a receiving unit which receives the first data transmitted from the first communication apparatus; an acquiring unit which acquires the time slot information from the first data received by the receiving unit; an acknowledgement data generating unit which generates acknowledgement data corresponding to the first data; and a transmitting unit which adds the time slot information to the acknowledgement data to transmit the acknowledgement data with the time slot information.

With employment of the above-described arrangement, since a total number of the communication apparatuses which fail in acquisitions of the time slot information can be reduced, probability at which the frames may collide with each other on the transmission channel can be lowered, so that the transmission efficiency of the communication apparatus can be improved.

Also, the above-described communication system includes: the above-described communication apparatus as a first communication apparatus; and a second communication apparatus including: a receiving unit which receives the first data and the second data transmitted by the first communication apparatus; an acquiring unit which acquires the time slot information from the first data received by the receiving unit; a control data generating unit which generates a control data containing information for controlling a communication with respect to the first communication apparatus; and a transmitting unit which adds the time slot information to the control data to transmit the control data with the time slot information.

With employment of the above-described arrangement, since a total number of the communication apparatuses which fail in acquisitions of the time slot information can be reduced, probability at which the frames may collide with each other on the transmission channel can be lowered, so that the transmission efficiency of the communication apparatus can be improved.

Also, in the above-described communication system, the second communication apparatus further includes a calculating unit which calculates a time cycle of the time slot based upon reception time instant when the receiving unit receives both the first data and the second data, and the transmitting unit of the second communication apparatus adds time cycle information indicating the time cycle to the control data to transmit the control data with the time cycle information

With employment of the above-described arrangement, since a total number of the communication apparatuses which fail in acquisitions of the time slot information can be reduced, probability at which the frames may collide with each other on the transmission channel can be lowered, so that the transmission efficiency of the communication apparatus can be improved.

Also, in the above-described communication system, the second communication apparatus further includes a transmission prohibition setting unit which sets the time slot indicated in the time slot information as a time range for prohibiting the data transmission.

With employment of the above-described arrangement, since a total number of the communication apparatuses which fail in acquisitions of the time slot information can be reduced, probability at which the frames may collide with each other on the transmission channel can be lowered, so that the transmission efficiency of the communication apparatus can be improved.

Also, in the above-described communication apparatus, the second communication apparatus further includes a transmission prohibition setting unit which sets a time range for prohibiting the data transmission based upon the time cycle information.

With employment of the above-described arrangement, since the period for prohibiting the data transmission in the periodic manner can be set, probability at which the frames may collide with each other on the transmission channel can be lowered, so that the transmission efficiency of the communication apparatus can be improved.

Also, the above-described communication apparatus has employed a power line as the above-described transmission channel.

With employment of the above-described arrangement, in the power line communication, the data whose delay condition is restricted can be transmitted while the QoS (Quality of Service) is maintained. Moreover, since the time slot reservation-purpose overhead is decreased, the time slots on the power line can be effectively utilized, so that the communication efficiency of the power line communication can be improved.

Also, in the above-described communication method, the time slot information includes transmission starting time instant information indicating a transmission starting time instant of the second data, and time slot width information indicating the time slot width of the time slot.

With employment of the above-described arrangement, the time slot information corresponding to the time slots during which the second data transmitted at the second timing subsequent to the first timing is transmitted through the transmission channel is applied to the first data transmitted at the first timing. As a result, the data whose delay condition is restricted can be transmitted while the QoS (Quality of Service) is maintained. Furthermore, since the time slot reservation-purpose overhead is decreased, the time slots on the transmission channel can be effectively utilized, so that the transmission efficiency can be improved.

Also, in the above-described communication method, the first data and the second data are transmitted in the predetermined time cycle.

With employment of the above-described arrangement, the data transmission for transmitting the data in the periodic manner can be carried out while the QoS (Quality of Service) is maintained.

Also, the above-described communication method further includes receiving the first data; acquiring the time slot information from the first data; generating acknowledgement data corresponding to the first data; adding the time slot information to the acknowledgement data; and transmitting the acknowledgement data with the time slot information.

With employment of the above-described arrangement, since a total number of the communication apparatuses which fail in acquisitions of the time slot information can be reduced, probability at which the frames may collide with each other on the transmission channel can be lowered, so that the transmission efficiency of the communication apparatus can be improved.

Also, the above-described communication method further includes receiving the first data and the second data; acquiring the time slot information from the first data; generating control data containing information for controlling a communication; adding the time slot information to the control data; and transmitting the control data with the time slot information.

With employment of the above-described arrangement, since a total number of the communication apparatuses which fail in acquisitions of the time slot information can be reduced, probability at which the frames may collide with each other on the transmission channel can be lowered, so that the transmission efficiency of the communication apparatus can be improved.

Also, the above-described communication method further includes: calculating a time cycle of the time slots based upon reception time instants when both the first data and the second data are received; and adding time cycle information corresponding to the calculated time cycle to the control data.

With employment of the above-described arrangement, since a total number of the communication apparatuses which fail in acquisitions of the time slot information can be reduced, probability at which the frames may collide with each other on the transmission channel can be lowered, so that the transmission efficiency of the communication apparatus can be improved.

Also, the above-described communication method further includes setting the time slot indicated in the time slot information as a time range for prohibiting the data transmission.

With employment of the above-described arrangement, since a total number of the communication apparatuses which fail in acquisitions of the reservation information can be reduced, probability at which the frames may collide with each other on the transmission channel can be lowered, so that the transmission efficiency of the communication apparatus can be improved.

Also, the above-described communication method further includes setting a time range for prohibiting the data transmission based upon the time cycle information.

With employment of the above-described arrangement, since the period for prohibiting the data transmission can be set in the periodic manner, probability at which the frames may collide with each other on the transmission channel can be lowered, so that the transmission efficiency of the communication apparatus can be improved.

Also, in the above-described communication method, a power line has been employed as the transmission channel.

With employment of the above-described arrangement, in the power line communication, the data whose delay condition is restricted can be transmitted while the QoS (Quality of Service) is maintained. Moreover, since the time slot reservation-purpose overhead is decreased, the time slots on the power line can be effectively utilized, so that the communication efficiency of the power line communication can be improved.

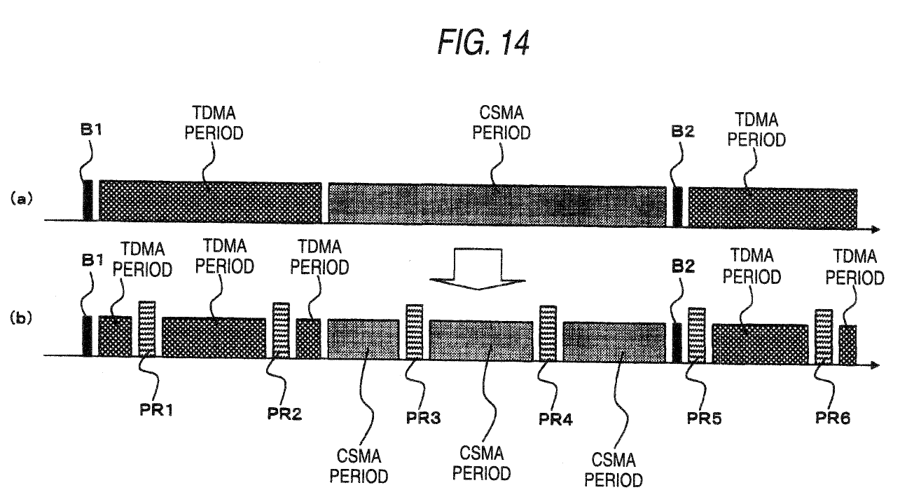

In the above-described communication system, the data frame equipped with the time slot reservation has been transmitted so as to establish the time slot reservation. Alternatively, other time slot reservation systems may be employed in combination with the above-described time slot reservation system. In this alternative case, it is preferable to execute this time slot reservation system prior to other systems. As indicated in FIG. 14(a), both the CSMA system and the TDMA system have been allocated to a specific period between annunciation frames B1 and B2. In such a system, when the data frame equipped with the time slot reservation is transmitted in order to establish the time slot reservation, as shown in FIG. 14(b), reservation period (namely, transmission prohibition period in other communication apparatuses) are set prior to the CSMA system and the TDMA system, and data frames “PR1” to “PR6” equipped with the time slot reservations are transmitted from the reserved communication apparatus.

Further, the above-explained communication system may be applied not only to power line communications, but also to wireless communication.

The present invention is useful as the communication method, the communication apparatus, and the integrated circuit for accomplishing the communication method capable of performing the transmission of the cyclic data, the delay condition of which is restricted, while the QoS (Quality of Service) is maintained.

This application is based upon and claims the benefit of priority of Japanese Patent Application No. 2007-145973 filed on May 31, 2008, the contents of which are incorporated herein by reference in its entirety.

What is claimed is:

1. A communication apparatus for communicating by commonly sharing a transmission channel with another communication apparatus which performs a data transmission, comprising:
a transmitting unit which transmits first data at first timing and second data at second timing subsequent to the first timing to the transmission channel; and
an information adding unit which adds time slot information to the first data, the time slot information indicating a time slot during which the second data is transmitted prior to the data transmission performed by said other communication apparatus.

2. The communication apparatus as claimed in claim 1, wherein the time slot information contains transmission starting time instant information indicating a transmission starting time instant of the second data, and time slot width information indicating a time slot width of the time slot.

3. The communication apparatus as claimed in claim 1, wherein the transmitting unit transmits both the first data and the second data in a predetermined time cycle.

4. A communication system for communicating by commonly sharing a transmission channel, comprising:
the communication apparatus recited in claim 1 as a first communication apparatus; and
a second communication apparatus including:
a receiving unit which receives the first data transmitted from the first communication apparatus;
an acquiring unit which acquires the time slot information from the first data received by the receiving unit;
an acknowledgement data generating unit which generates acknowledgement data corresponding to the first data; and
a transmitting unit which adds the time slot information to the acknowledgement data to transmit the acknowledgement data with the time slot information.

5. A communication system for communicating by commonly sharing a transmission channel, comprising:
the communication apparatus recited in claim 1 as a first communication apparatus; and
a second communication apparatus including:
a receiving unit which receives the first data and the second data transmitted by the first communication apparatus;
an acquiring unit which acquires the time slot information from the first data received by the receiving unit;
a control data generating unit which generates a control data containing information for controlling a communication with respect to the first communication apparatus; and
a transmitting unit which adds the time slot information to the control data to transmit the control data with the time slot information.

6. The communication system as claimed in claim 5, wherein the second communication apparatus further includes a calculating unit which calculates a time cycle of the time slot based upon reception time instant when the receiving unit receives both the first data and the second data,
wherein the transmitting unit of the second communication apparatus adds time cycle information indicating the time cycle to the control data to transmit the control data with the time cycle information.

7. The communication system as claimed in claim 4, wherein the second communication apparatus further includes a transmission prohibition setting unit which sets the time slot indicated in the time slot information as a time range for prohibiting the data transmission.

8. The communication system as claimed in claim 6, wherein the second communication apparatus further includes a transmission prohibition setting unit which sets a time range for prohibiting the data transmission based upon the time cycle information.

9. The communication apparatus as claimed in claim 1, wherein the transmission channel is a power line.

10. A communication method for communicating by commonly sharing a transmission channel with a communication apparatus which performs a data transmission, comprising:
transmitting first data at first timing to the transmission channel;
transmitting second data at second timing subsequent to the first timing to the transmission channel; and
adding time slot information to the first data, the time slot information indicating a time slot during which the second data is transmitted prior to the data transmission performed by another communication apparatus.

11. The communication method as claimed in claim 10, wherein the time slot information contains transmission starting time instant information indicating a transmission starting time instant of the second data, and time slot width information indicating the time slot width of the time slots.

12. The communication method as claimed in claim 10, wherein both the first data and the second data are transmitted in a predetermined time cycle.

13. The communication method as claimed in claim 10, further comprising:
receiving the first data;
acquiring the time slot information from the first data;
generating acknowledgement data corresponding to the first data;
adding the time slot information to the acknowledgement data; and
transmitting the acknowledgement data with the time slot information.

14. The communication method as claimed in claim 10, further comprising:
receiving the first data and the second data;
acquiring the time slot information from the first data;
generating control data containing information for controlling a communication;
adding the time slot information to the control data; and
transmitting the control data with the time slot information.

15. The communication method as claimed in claim 14, further comprising:
calculating a time cycle of the time slots based upon reception time instants when both the first data and the second data are received; and
adding time cycle information corresponding to the calculated time cycle to the control data.

16. The communication method as claimed in claim 13, further comprising:
setting the time slot indicated in the time slot information as a time range for prohibiting the data transmission.

17. The communication method as claimed in claim 15, further comprising:
setting a time range for prohibiting the data transmission based upon the time cycle information.

18. The communication method as claimed in claim 10, wherein the transmission channel is a power line.

19. An integrated circuit employed in a communication apparatus for communicating by commonly sharing a transmission channel with another communication apparatus which performs a data transmission, comprising:
a transmitting unit which transmits first data at first timing and second data at second timing subsequent to the first timing to the transmission channel; and
an information adding unit which adds time slot information to the first data, the time slot information indicating a time slot during which the second data is transmitted prior to the data transmission performed by said other communication apparatus.
